(19) United States
(12) Patent Application Publication
(10) Pub. No.: US 2008/0272687 A1
(43) Pub. Date: Nov. 6, 2008

(54) White light LED

(76) Inventor: Wen-Te Lin, Taichung City (TW)

Correspondence Address: WEN-TE LIN, 235 Chung-Ho, Box 8-24, Taipei, TW

(21) Appl. No.: 11/799,480

(22) Filed: May 2, 2007

(51) Int. Cl. H01J 1/62

(52) U.S. Cl. 313/502

(57) ABSTRACT

A white light LED having a supporting frame; at least one light emitting chip being installed on the supporting frame; a transparent body covering upon the chip; the transparent body being mixed with florescent powders. The florescent powders causes that light emitted from the chip and then passing through the transparent body will present as white light. The chip is a blue-light light emitting chip or an ultraviolet-light light emitting chip and the florescent powders is yellow florescent powders. The supporting frame has two pins. The transparent body is made by at least one of silicide gel, glass, epoxy resin, and epoxy resin with silicide. The transparent body encloses a part of the supporting frame.

### FIELD OF THE INVENTION

The present invention relates to LEDs, and particularly to a white light LED which has at least one light emitting chip being installed on the supporting frame; a transparent body covering upon the chip; the transparent body being mixed with florescent powders; the florescent powders causes that light emitted from the chip and then passing through the transparent body will present as white light. The structure of the present invention can increase the adding effect of the blue light (or ultraviolet light) and the yellow florescent powders 41. The generated white light is uniform without aureola effect or aberration.

### BACKGROUND OF THE INVENTION

White light is formed by mixing a plurality of lights with different wavelengths. Thus it cannot be generated directly from a chip. Current way for generating white light by LED can be divided into three wavelengths form and two wavelengths form. The former mixes three kinds of light emitting chips of red light, blue light and green light, and uses an ultraviolet-light light emitting chip to stimulate mixed red florescent powders, green florescent powders and green florescent powders. The three wavelength white light LED is difficult in control and mixing of lights. Thus the cost is high and effect is bad. It is not accepted by current markets.

Two wavelength form white light LED uses a blue-light light emitting chip or an ultraviolet-light light emitting chip with yellow florescent powders. When light emitted from the blue-light light emitting chip or ultraviolet-light light emitting chip passes through yellow florescent powders, white light will be got.

Referring to FIGS. 1 and 2, a prior art two wavelength form white light LED is illustrated. A color chip 90 is placed in a cup of a pin 91. Then the chip 90 is connected to another pin through a bonding wire 92. Then florescent powders layer 93 covers upon the outer side of the chip 90. Finally, a transparent body 94 encloses the upper half portion of the two pins and encloses the chip 90 and the florescent powders layer 93, as illustrated in FIGS. 2 and 3 so as to form a prior art white light LED.

However in the prior art structure, since the florescent powders in the florescent powders layer 93 has different deposit speed so that the density in different part of the florescent powders layer is very different and thus it is non-uniform. As a result, aureola effect or aberration will generate.

In another prior art way, the florescent powders are mixed into a transparent thin layer, then the thin layer covers upon the chip and then a transparent body encloses the pins, the chip and the thin layer.

However above mentioned structure can increase the uniformity of the florescent powders in the thin layer, but the manufacturing processes are tedious. Furthermore, the thin layer is very thin. For example, for the blue-light light emitting chip, since yellow florescent powders have lower possibility to be stimulate by blue light so that the emitted two wavelength form white contains a great deal of blue light which occupies a larger part of the light spectrum of the white light so that the color temperature is high and the light of the light source is difficult to be controlled. Therefore, it is known that this prior art way needs higher cost and has bad quality.

### SUMMARY OF THE INVENTION

Accordingly, the primary object of the present invention is to provide a white light LED which has at least one light emitting chip being installed on the supporting frame; a transparent body covering upon the chip; the transparent body being mixed with florescent powders; the florescent powders cause that light emitted from the chip and then passing through the transparent body will present as white light. The structure of the present invention can increase the adding effect of the blue light (or ultraviolet light) and the yellow florescent powders. The generated white light is uniform without aureola effect or aberration.

To achieve above objects, the present invention provides a white light LED having a supporting frame; at least one light emitting chip being installed on the supporting frame; a transparent body covering upon the chip; the transparent body being mixed with florescent powders; the florescent powders causes that light emitted from the chip and then passing through the transparent body will present as white light. The chip is a blue-light light emitting chip or an ultraviolet-light light emitting chip and the florescent powders is yellow florescent powders. The supporting frame has two pins. The transparent body 40 is made by at least one of silicide gel, glass, epoxy resin, and epoxy resin with silicide. The transparent body encloses a part of the supporting frame.

The various objects and advantages of the present invention will be more readily understood from the following detailed description when read in conjunction with the appended drawing.

### BRIEF DESCRIPTION OF THE DRAWINGS

FIGS. 1 and 2 are structural views of the prior art white light LED.

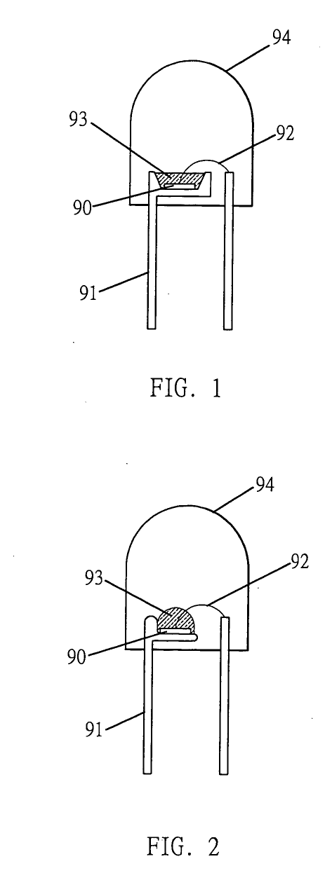

FIG. 3 is a schematic cross sectional view of the white light LED of the present invention.

FIG. 4 is a schematic view showing the second embodiment of the present invention.

FIG. 5 is a schematic view showing the third embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

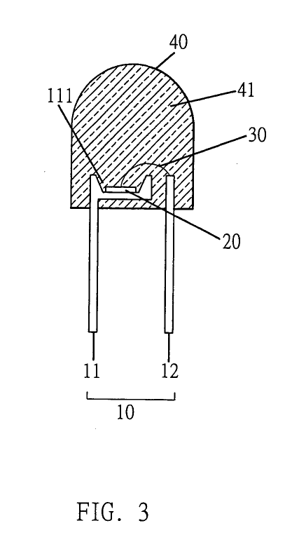

Referring to FIG. 3, the white light LED (LED: light emitting diode) of the present invention is illustrated. The structure of the white light LED includes a supporting frame 10. The supporting frame 10 includes a first pin 11 and a second pin 12. An upper side of the first pin 11 is formed with a cup with a receiving section 111. A chip 20 is installed in the receiving section 111. The chip 20 is a blue-light light emitting chip with a wavelength from 400 to 530 nm (nanometers) or an ultraviolet-light light emitting chip with a wavelength from 390 to 410 nm. However the wavelength of the chip 20 is not confined to these two ranges.

The chip 20 installed in the receiving section 111 of the first pin 11 is connected to the second pin 12 through a bonding wire 30. A transparent body 40 encloses the chip 20 for enhancing the illumination. Furthermore, the transparent body 40 encloses a part of the supporting frame 10 so as to well protect the chip 20.

The transparent body 40 is made by at least one of silicide gel, glass, epoxy resin, and epoxy resin with silicide. Furthermore, the transparent body 40 is mixed with florescent powders 41 which can generate white light as covering upon the chip 20. In this embodiment, the florescent powders 41 is yellow light florescent powders 41 corresponding to the blue-light light emitting chip and ultraviolet-light light emitting chip.

In use, the first pin 11 and second pin 12 are conducted so that the chip 20 is conducted and thus the chip 20 will emit blue light or ultraviolet light. The light from the chip 20 will pass through the transparent body 40 having yellow florescent powders 41. After passing through the transparent body 40, white light is presented from the LED.

In the present invention, the florescent powders 41 are mixed in the transparent body 40 uniformly. The thickness or shape of the transparent body 40 is not confined. The structure of the present invention can increase the adding effect of the blue light (or ultraviolet light) and the yellow florescent powders 41. The generated white light is uniform without florescent powders 41. Further, the florescent powders 41 is directly mixed into the transparent body 40. The manufacturing process is convenient and the cost is down.

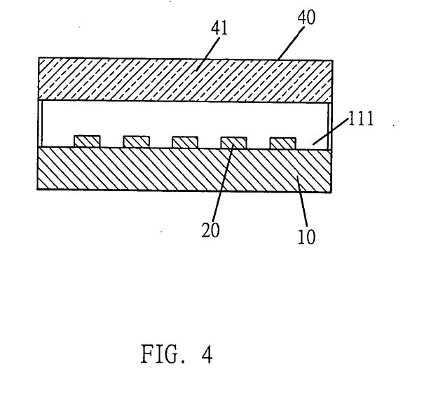

Referring to FIG. 4, the second embodiment about the white light LED of the present invention is illustrated. In this embodiment, those identical to the above embodiment will not be further described herein. Only those different from above embodiment are described.

In this embodiment, a plurality of chips 20 are placed in the receiving section 111.

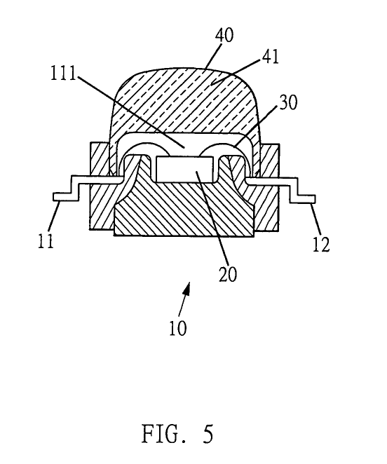

Referring to FIG. 5, the third embodiment of the present invention is illustrated. In this embodiment, those identical to the above embodiment will not be further described herein. Only those different from above embodiment are described.

In this embodiment, it is illustrated that not only suitable for low power LED, the present invention is suitable for high power LED. It is illustrated that a receiving section 111 is placed with a chip 20. The chip 20 is connected to the first pin 11 and second pin 12 by respective bonding wires 30.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A white light LED having a supporting frame; at least one blue-light light emitting chip being installed on the supporting frame; a transparent body covering upon the chip; the transparent body being mixed with yellow florescent powders so that after light emitted from the chip passing through the transparent body, uniform white light being emitted from the transparent body.

2. The white light LED as claimed in claim 1, wherein the supporting frame has two pins.

3. The white light LED as claimed in claim 1, wherein the transparent body is made by at least one of silicide gel, glass, epoxy resin, and epoxy resin with silicide.

4. The white light LED as claimed in claim 1, wherein a plurality of blue-light light emitting chip are installed on the supporting frame.

5. The white light LED as claimed in claim 1, wherein the transparent body encloses a part of the supporting frame.

6. A white light LED having a supporting frame; at least one light emitting chip being installed on the supporting frame; a transparent body covering upon the chip; the transparent body being mixed with florescent powders; the florescent powders causes that light emitted from the chip and then passing through the transparent body will present as white light.

7. The white light LED as claimed in claim 6, wherein the chip is an ultraviolet-light light emitting chip.

8. The white light LED as claimed in claim 6, wherein the florescent powders is yellow florescent powders.

9. The white light LED as claimed in claim 6, wherein the supporting frame has two pins.

10. The white light LED as claimed in claim 6, wherein the transparent body is made by at least one of silicide gel, glass, epoxy resin, and epoxy resin with silicide.

11. The white light LED as claimed in claim 6, wherein a plurality of blue-light light emitting chip are installed on the supporting frame.

12. The white light LED as claimed in claim 6, wherein the transparent body encloses a part of the supporting frame.
